(19) United States
(12) Patent Application Publication
(10) Pub. No.: US 2025/0158642 A1
(43) Pub. Date: May 15, 2025

(54) RF FRONT-END MODULE AND METHOD OF TRANSMITTING SIGNALS BASED ON THE SAME

(71) Applicant: SAMSUNG ELECTRONICS CO., LTD., SUWON-SI (KR)

(72) Inventor: Luo Jia, Shenzhen (CN)

(73) Assignee: Samsung Semiconductor China Research & Development Co., LTD., Suzhou (CN)

(21) Appl. No.: 18/430,837

(22) Filed: Feb. 2, 2024

(30) Foreign Application Priority Data
Nov. 13, 2023 (CN) 202311503715.4

(51) Int. Cl. H04B 1/04; H04B 1/00

(52) U.S. Cl. CPC H04B 1/04; H04B 1/0057; H04B 2001/0408

(57) ABSTRACT

An RF front-end module and a method of transmitting signals based on an RF front-end module is provided. The RF front-end module includes an RF transceiver comprising first to fourth transmitting interfaces, a pathway selection switch connected to the first and second transmitting interfaces and for selecting, from among the first and second transmitting interfaces, an interface matching with a frequency of the network cell in which it is currently located, and an amplifier. The first and second transmitting interfaces are each selectively connected to the amplifier via the pathway selection switch. The first or third transmitting interface is used as an interface for a first transmitting pathway. The second or fourth transmitting interface is used as an interface for a second transmitting pathway. This may enable multiplexing of an LTE transmitting pathway and 5G dual connectivity (ENDC) scenarios through internal switching of the first and second transmitting interfaces.

### CROSS REFERENCE TO RELATED APPLICATION

This application claims priority to Chinese Patent Application No. 202311503715.4 filed on Nov. 13, 2023 in the China intellectual property office, the content of which is incorporated herein by reference in its entirety.

### TECHNICAL FIELD

The present disclosure relates to the field of communication technology. More particularly, the present disclosure relates to an RF front-end module and a method of transmitting signals based on the same.

### DISCUSSION OF RELATED ART

Currently, for the RF front-end architecture of 5G terminals, a transmitting module may include a Radio Frequency Integrated Circuit (RFIC), a Low Band Power Amplifier Module Integrated Duplexer (LB PAMID), a Medium-High (Medium and/or High) Band Power Amplifier Module Integrated Duplexer (MHB PAMID), and an Ultra-High Band Power Amplifier Module Integrated Duplexer (UHB PAMID). (Approximate frequency bands may be: LB≈600-850 MHz; MB≈1650-2200 MHz; HB≈2300-2700 MHZ; and UHB≈3.3-5 GHz.)

Long Term Evolution (LTE) and 5G dual connectivity may be referred to as ENDC. ENDC is a Non-StandAlone (NSA) function (a function using an LTE core network) that allows mobile devices (UEs) to connect to 5G and 4G (LTE) networks simultaneously, and enables operators to leverage the wireless resources of both network technologies simultaneously.

Because both the Low Band and Medium-High Band (LMH band) may be needed to form an LTE and 5G dual connection (ENDC), in a current architecture, the LB PAMID and the MHB PAMID occupy TX1 (an LTE based transmission path) and the UHB PAMID occupies TX2 (a 5G based transmission path) to meet the requirement.

For the n28 band (generally 600-850 MHz, or 703-748 MHz on uplink, 758-803 MHz on downlink), this current architecture can meet the requirement of Standalone (SA only) (connectivity using a 5G core without a 4G core) at present. However, as operators use the 700 MHz band more often and more extensively, the requirements for n28 ENDC combinations, such as B1/B3+n28 (B1=2100 MHZ band and B3=1800 MHz band), may not be met by the current architecture. In one approach, to realize the ENDC combination of medium-high band (MHB)+n28, another Low Band Power Amplifier (LB PA) is introduced to achieve this function. However, this approach both increases the hardware Bill Of Materials (BOM) cost of the TX pathway such as Power Amplifier (PA)/Transmitting Surface Acoustic Wave (TX SAW) device/antenna, and also renders the Printed Circuit Board (PCB) design more difficult.

### SUMMARY

Exemplary embodiments of the present disclosure provide an RF front-end module and a method of transmitting signals based on the same, to achieve new combinations of E-UTRAN New Radio Dual Connectivity (ENDC) without increasing the hardware cost and difficulty of Printed Circuit Board (PCB) design.

According to exemplary embodiments of the present disclosure, there is provided an RF front-end module including an RF transceiver comprising a first transmitting interface, a second transmitting interface, a third transmitting interface, and a fourth transmitting interface, a pathway selection switch connected to the first transmitting interface and the second transmitting interface and for selecting, from among the first transmitting interface and the second transmitting interface, an interface matching with a frequency of the network cell in which the RF transceiver is currently located, and a first amplifier module, wherein the first transmitting interface and the second transmitting interface are selectively connected to the first amplifier module via the pathway selection switch, wherein one of the first transmitting interface and the third transmitting interface is used as an interface for a first transmitting pathway, and one of the second transmitting interface and the fourth transmitting interface is used as an interface for a second transmitting pathway. In various examples:

The RF front-end module may enable multiplexing of a Long Term Evolution (LTE) transmitting pathway in LTE and 5G dual connectivity (ENDC) scenarios through internal switching of the first transmitting interface and the second transmitting interface (e.g., TX1/TX2).

The RF front-end module may further include a second amplifier module connected to the third transmitting interface, and a third amplifier module connected to the fourth transmitting interface.

The first amplifier module may be a low frequency amplifier module, the second amplifier module may be a medium-high frequency amplifier module, and the third amplifier module may be a high frequency amplifier module.

The first transmitting interface may be a long term evolution transmitting interface, the second transmitting interface may be a 5G low frequency transmitting interface, the third transmitting interface may be a medium-high frequency transmitting interface, and the fourth transmitting interface may be an ultra-high frequency transmitting interface.

The first transmitting pathway and the second transmitting pathway may be simultaneously in an operating state.

The first amplifier module may be used for long-term evolution signal transmission or 5G low-frequency signal transmission.

According to exemplary embodiments of the present disclosure, there is provided a method of transmitting signals based on an RF front-end module, the RF front-end module including an RF transceiver, a pathway selector switch, and a first amplifier module, wherein the RF transceiver includes a first transmitting interface, a second transmitting interface, a third transmitting interface, and a fourth transmitting interface, the first transmitting interface and the second transmitting interface being selectively connected to the first amplifier module via the pathway selector switch, and the method includes selecting a first signal transmitting interface from among the first transmitting interface and the second transmitting interface of the RF transceiver and selecting a second signal transmitting interface from among the third transmitting interface and the fourth transmitting interface of the RF transceiver, based on the frequency of the network cell in which the RF transceiver is currently located, controlling the pathway selector switch to establish a first transmitting pathway by connecting the first signal transmitting interface to the first amplifier module, transmitting a first signal through the first transmitting pathway and transmitting a second signal through a second transmitting pathway corresponding to the second signal transmitting interface.

According to exemplary embodiments of the present disclosure, there is provided a computer-readable storage medium having a computer program stored thereon, and when the computer program is executed by a processor, the method of transmitting signals based on an RF front-end module according to the exemplary embodiments of the present disclosure is implemented.

According to the exemplary embodiments of the present disclosure, there is provided a computing device including at least one processor, and at least a memory storing a computer program, wherein when the computer program is executed by the processor, the method of transmitting signals based on an RF front-end module according to the exemplary embodiments of the present disclosure is implemented.

Additional aspects and/or advantages of the general concept of the present disclosure will be partially explained in the following description, and still others will be clear from the description, or may be known through the implementation of the general concept of the present disclosure.

### BRIEF DESCRIPTION OF DRAWINGS

The above and other features of exemplary embodiments of the present disclosure will become clearer through the following description in conjunction with the drawings that exemplarily illustrate embodiments, wherein:

FIG. 1A shows a block diagram of an example of an RF front-end module according to an exemplary embodiment of the present disclosure;

FIG. 1B shows a block diagram of another example of the RF front-end module according to an exemplary embodiment of the present disclosure;

FIG. 2 shows one example of the RF front-end module according to an exemplary embodiment of the present disclosure;

FIG. 3 shows a schematic diagram for implementing the switch of transmitting paths according to an exemplary embodiment of the present disclosure;

FIG. 4 shows a flow chart of a method of transmitting signals based on the RF front-end module according to an exemplary embodiment of the present disclosure; and

FIG. 5 shows a schematic diagram of the computing device according to an exemplary embodiment of the present disclosure.

### DETAILED DESCRIPTION OF EXEMPLARY EMBODIMENTS

Reference will now be made in detail to exemplary embodiments of the present disclosure, examples of which are illustrated in the drawings, wherein like reference numerals refer to like elements throughout the drawings.

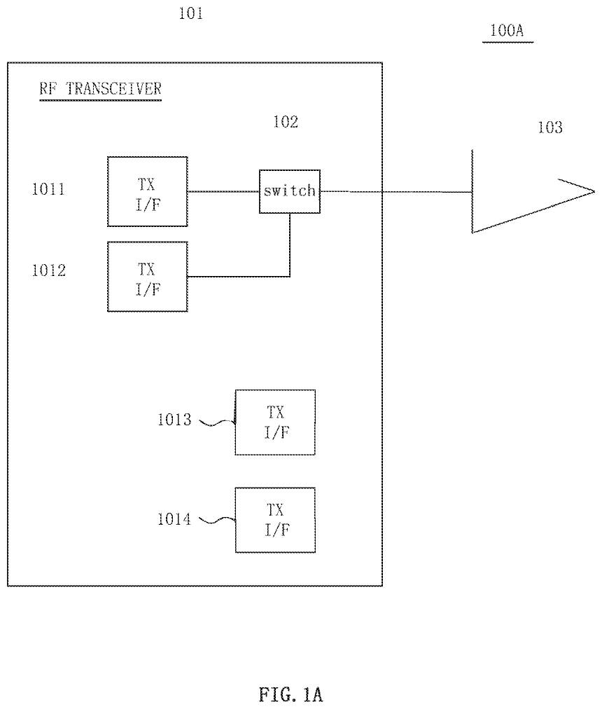

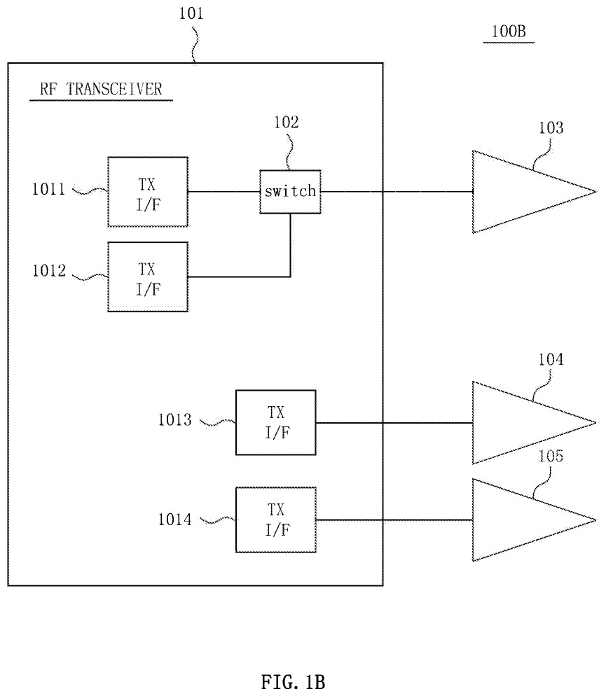

FIG. 1A shows a block diagram of an example of an RF front-end module, 100A, according to an exemplary embodiment of the present disclosure. FIG. 1B shows a block diagram of another example of the RF front-end module, 100B, according to an exemplary embodiment of the present disclosure.

Referring to FIG. 1A, the RF front-end module 100A includes an RF transceiver 101, a pathway selection switch 102, and a first amplifier module 103. Herein, the RF transceiver 101 may be used to receive and/or transmit signals.

In an exemplary embodiment of the present disclosure, the RF transceiver 101 includes first, second, third and fourth transmitting interfaces 1011, 1012, 1013 and 1014, respectively.

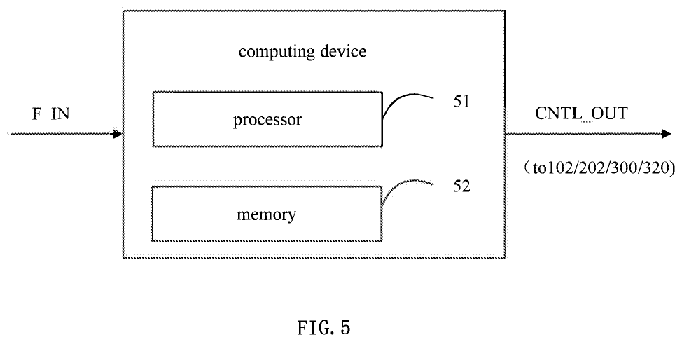

The pathway selection switch 102 may be connected to the first transmitting interface 1011 and the second transmitting interface 1012, and may be controlled to select, from among the first and second transmitting interfaces 1011 and 1012, an interface matching with a frequency of the network cell in which the RF front-end module 100A is currently located. To this end, the pathway selection switch 102 may receive a control signal from a computing device (discussed later in reference to FIG. 5) that controls its switching state.

The first transmitting interface 1011 and the second transmitting interface 1012 may be selectively connected to the first amplifier module 103 via the pathway selection switch 102.

In addition, referring to FIG. 1B, the RF front-end module 100B may further include a second amplifier module 104 and a third amplifier module 105. The second amplifier module 104 may be connected to the third transmitting interface 1013, and the third amplifier module 105 may be connected to the fourth transmitting interface 1014.

In the RF front-end modules 100A and 100B, in a first state, the first transmitting interface 1011 may be connected to the first amplifier module 103 via the pathway selection switch 102, and in a second state, the second transmitting interface 1012 may be connected to the first amplifier module 103 via the pathway selection switch 102.

In the RF front-end modules 100A and 100B, one of the first transmitting interface 1011 and the third transmitting interface 1013 may be used as an interface for a first transmitting pathway, and one of the second transmitting interface 1012 and the fourth transmitting interface 1014 may be used as an interface for a second transmitting pathway. For example, the first transmitting interface 1011 is used as the interface for the first transmitting pathway, and the fourth transmitting interface 1014 is used as the interface for the second transmitting pathway, thus forming an n28+Ultra-High Band (UHB) combination for ENDC. In another example, the third transmitting interface 1013 is used as the interface for the first transmitting pathway, and the fourth transmitting interface 1014 is used as the interface for the second transmitting pathway, thus forming a Medium Band (MB)+Ultra-High Band (UHB) combination, or a High Band (HB)+Ultra-High Band (UHB) combination for ENDC. In still another example, the third transmitting interface 1013 is used as the interface for the first transmitting pathway, and the second transmitting interface 1012 is used as the interface for the second transmitting pathway, thus forming a n28+Medium Band (MB) combination, or a n28+High Band (HB) combination for ENDC.

The first amplifier module 103 may be a low frequency amplifier module, the second amplifier module 104 may be a medium-high (medium and/or high) frequency amplifier module, and the third amplifier module 105 may be an ultra-high frequency amplifier module. (Exemplary frequency ranges for the low band, medium band, high band and ultra high band were given earlier. However, the exemplary frequency ranges are not limited thereto, and the frequency ranges may be variously divided according to a frequency operation for respective service providers.)

The first transmitting interface 1011 may be a long term evolution transmitting interface (LTE, i.e., 4G), the second transmitting interface 1012 may be a 5G low frequency transmitting interface, the third transmitting interface 1013 may be a medium-high frequency transmitting interface, and the fourth transmitting interface 1014 may be an ultra-high frequency transmitting interface. For example, the second transmitting interface 1012 may be used to transmit signals in the band between 600 MHz-850 MHz, e.g., the n28 band.

The first transmitting pathway and the second transmitting pathway may be in an operating state simultaneously, thus enabling 4G and 5G dual connectivity and thereby enabling ENDC.

The first amplifier module 103 may be used for LTE signal transmission or 5G low-frequency signal transmission.

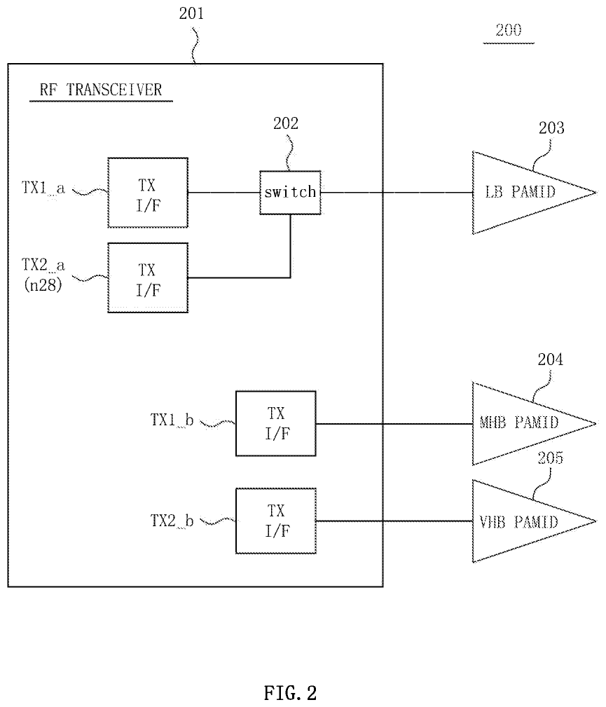

FIG. 2 is a block diagram of an RF front-end module, 200, which is an example of the RF front-end module 100B. In FIG. 2, the n28 band (a 5G signal) may be multiplexed (e.g., time multiplexed via the pathway selection switch 202) with an LTE signal, and the multiplexed signal may be applied to a Low Band Power Amplifier Module Integrated Duplexer (LB PAMID) 203 to form one of the transmission (TX) pathways.

The RF front-end module 200 may include an RF transceiver 201, the pathway selection switch 202, the LB PAMID 203 (an example of a low frequency amplifier module), a medium-high frequency amplifier module 204, and a third amplifier module 205. The low frequency amplifier module 203 is/includes a LB PAMID, the medium-high frequency amplifier module 204 is/includes a Medium-High Band Power Amplifier Module Integrated Duplexer (MHB PAMID), and the ultra-high frequency amplifier module 205 is/includes an Ultra-High Band Power Amplifier Module Integrated Duplexer (UHB PAMID).

The RF transceiver 201 may be used to receive and/or transmit signals, and may include two interfaces TX1_a and TX1_b as part of a first transmitting pathway and two interfaces TX2_a and TX2_b as part of a second transmitting pathway.

The pathway selection switch 202 may be used to select (via a control signal applied thereto) the first signal transmitting interface that matches with the frequency of the network cell in which the RF front-end module 200 is currently located.

In an exemplary embodiment of the present disclosure, one interface TX1_a as part of a first transmitting pathway, and one interface TX2_a as part of a second transmitting pathway, are selectively connected to the low frequency amplifier module 203 via the pathway selection switch 202.

In an exemplary embodiment of the present disclosure, the medium-high frequency amplifier module 204 may be connected to the interface TX1_b as part of the first transmitting pathway, and the ultra-high frequency amplifier module 205 may be connected to the interface TX2_b as part of the second transmitting pathway.

In an exemplary embodiment of the present disclosure, in a first state, the interface TX1_a as part of the first transmitting pathway is connected to the low frequency amplifier module 203 via the pathway selection switch 202, and in a second state, the interface TX2_a as part of the second transmitting pathway is connected to the low frequency amplifier module 203 via the pathway selection switch 202.

In an exemplary embodiment of the present disclosure, one of the two interfaces TX1_a and TX1_b as part of the first transmitting pathway is in the operating state, and one of the two interfaces TX2_a and TX2_b as part of the second transmitting pathway is in the operating state. In this case, a single one of the interfaces TX1_a or TX1_b and a single one of the interfaces TX2_a or TX2_b in FIG. 2 is in the operating state at the same time.

In an exemplary embodiment of the present disclosure, the two interfaces TX1_a and TX1_b as part of the first transmitting pathway are the LTE transmitting interface and the 5G low-frequency transmitting interface, respectively, and the two interfaces TX2_a and TX2_b as part of the second transmitting pathway are the medium-high frequency transmitting interface and the ultra-high band transmitting interface, respectively. For example, the interface TX1_a as part of the first transmitting pathway may be used to transmit signals in the band between 600 MHz-850 MHz, e.g., the n28 band. (The n28 band may be used for either LTE or 5G signals.)

In an exemplary embodiment of the present disclosure, the first transmitting pathway and the second transmitting pathway may be in an operating state simultaneously, thus enabling 4G and 5G dual connectivity and thereby enabling ENDC.

The low frequency amplifier module 203 may be used for LTE signal transmission or 5G low-frequency signal transmission.

The RF front-end module 200 may enhance the ENDC support capability of the n28 band, optimize the RF front-end architecture, save the hardware Bill Of Materials (BOM) costs for the corresponding transmitting (TX) pathway (e.g., Power Amplifier (PA)/Surface Acoustic Wave device (SAW), etc.), and facilitate Printed Circuit Board (PCB) alignment. As mentioned earlier, the E-UTRAN New Radio Dual Connectivity (ENDC) refers to LTE and 5G dual connectivity. The ENDC is a Non-StandAlone (NSA) function that allows mobile devices (UEs) to connect to both 5G and 4G (LTE) networks, and enables operators to leverage the wireless resources of both network technologies simultaneously.

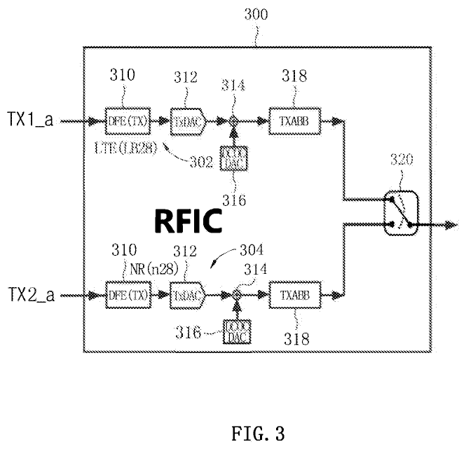

FIG. 3 shows a schematic diagram of switching circuitry for implementing the switching of transmitting paths according to an exemplary embodiment of the present disclosure. The switching circuitry may include a radio frequency integrated circuit (RFIC) 300 and a switch 320. Here, the switch 320 may be any of various types of switches. A single-pole, double-throw switch is illustrated as an example in FIG. 3, but the present disclosure does not limit this. For example, the switch 320 may also be a double-pole, double-throw switch. The RFIC 300 may include a “TX1_a” (LTE) transmitting chain 302 for processing and routing an LTE compatible signal (e.g., LTE (LB28) signal). A “TX2_a” (5G) transmitting chain 304 of the RFIC 300 may process a 5G compatible input signal (e.g., NR (n28) signal) and output the same at the n28 band. Each of the chains 302 and 304 may include a digital front end (DFE) 310 that receives and processes an input signal, a digital-to-analog converter (DAC) 312, a DC offset cancellation (DCOC) circuit 316, an adder 314, and an upconverter 318. Each upconverter 318 may output an upconverted signal to a respective input port of the switch 320.

When the LB PAMID 203 is used for an LTE pathway, the output signal of the TX1_a (LTE) chain 302 may be selected to provide the input signal to the LB PAMID 203. When the LB PAMID 203 is used as part of a 5G n28 band pathway, the output signal of the TX2_a chain 304 is selected to provide the input signal to the LB PAMID. Thus, in the Radio Frequency Integrated Circuit (RFIC), the Low Band (LB) and other Bands (e.g., the Medium Band MB) are separated into two transmitting (TX) paths to achieve n28 band LTE and 5G dual connectivity (ENDC). (Note that the LTE signal of the LTE pathway may also be in the n28 band when the LB PAMID 203 is used for the TX1 pathway.)

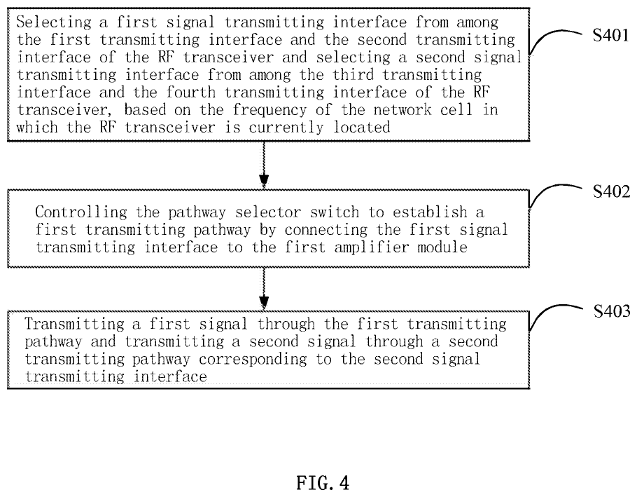

The RF front-end module according to the exemplary embodiments of the present disclosure has been described above in conjunction with FIGS. 1-3. Hereinafter, the method of transmitting signals based on the RF front-end module according to an exemplary embodiment of the present disclosure will be described with reference to FIG. 4.

FIG. 4 shows a flow chart of a method of transmitting signals based on the RF front-end module according to an exemplary embodiment of the present disclosure. Here, the RF front-end module may be any of the RF front-end modules described above. The RF front-end module includes an RF transceiver, a pathway selector switch, and a first amplifier module. The RF transceiver includes a first transmitting interface, a second transmitting interface, a third transmitting interface, and a fourth transmitting interface, where the first transmitting interface and the second transmitting interface is selectively connected to the first amplifier module via the pathway selector switch.

The RF front-end module may further include a second amplifier module, connected to the third transmitting interface, and a third amplifier module, connected to the fourth transmitting interface.

The first amplifier module may be a low frequency amplifier module, the second amplifier module may be a medium-high frequency amplifier module, and the third amplifier module may be a high frequency amplifier module.

The first amplifier module may be used for long-term evolution signal transmission or 5G low-frequency signal transmission.

Referring to FIG. 4, in operation S401, a first signal transmitting interface is selected from among the first transmitting interface and the second transmitting interface of the RF transceiver, and a second signal transmitting interface is selected from among the third transmitting interface and the fourth transmitting interface of the RF transceiver, based on the frequency of the network cell in which the RF transceiver is currently located.

In an exemplary embodiment of the present disclosure, the first transmitting interface may be an LTE transmitting interface, the second transmitting interface may be a 5G low frequency transmitting interface, the third transmitting interface may be a medium-high frequency transmitting interface, and the fourth transmitting interface may be an ultra-high frequency transmitting interface.

In operation S402, the pathway selector switch is controlled to establish a first transmitting pathway by connecting the first signal transmitting interface to the first amplifier module.

In an exemplary embodiment of the present disclosure, in a first state, the first transmitting interface is connected to the first amplifier module via the pathway selection switch, and in a second state, the second transmitting interface is connected to the first amplifier module via the pathway selection switch.

In operation S403, a first signal is transmitted through the first transmitting pathway and a second signal is transmitted through a second transmitting pathway corresponding to the second signal transmitting interface.

In an exemplary embodiment of the present disclosure, the first transmitting pathway and the second transmitting pathway are in an operating state simultaneously, thus enabling 4G and 5G dual connectivity and thereby enabling ENDC.

In addition, according to the exemplary embodiments of the present disclosure, there is also provided a computer-readable storage medium having a computer program stored thereon, and when the computer program is executed, a method of transmitting signals based on the RF front-end module according to the exemplary embodiments of the present disclosure is implemented.

In the exemplary embodiments of the present disclosure, the computer-readable storage medium may carry one or more programs that, when executed, may implement the following operations: selecting a first signal transmitting interface from among the first transmitting interface and the second transmitting interface of the RF transceiver and selecting a second signal transmitting interface from among the third transmitting interface and the fourth transmitting interface of the RF transceiver, based on the frequency of the network cell in which the RF transceiver is currently located, controlling the pathway selector switch to establish a first transmitting pathway by connecting the first signal transmitting interface to the first amplifier module, transmitting a first signal through the first transmitting pathway and transmitting a second signal through a second transmitting pathway corresponding to the second signal transmitting interface, wherein the RF front-end module comprising an RF transceiver, a pathway selector switch, and a first amplifier module, wherein the RF transceiver comprises a first transmitting interface, a second transmitting interface, a third transmitting interface, and a fourth transmitting interface, and the first transmitting interface and the second transmitting interface is selectively connected to the first amplifier module via the pathway selector switch.

The computer-readable storage medium can be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In embodiments of the present disclosure, a computer-readable storage medium may be any tangible medium that contains or stores a computer program that can be used by or in conjunction with an instruction execution system, apparatus, or device. The computer program contained on the computer-readable storage medium may be transmitted using any appropriate medium, including but not limited to: wire, fiber optic cable, RF (radio frequency), etc., or any suitable combination of the above. The computer-readable storage medium may be included in any device, or it may also exist as a standalone medium without being incorporated into the device.

In addition, according to exemplary embodiments of the present disclosure, there also provided a computer program product, wherein instructions in the computer program product can be executed by a processor of the computer device to complete the method of transmitting signals based on the RF front-end module according to the exemplary embodiments of the present disclosure.

The method of transmitting signals based on the RF front-end module according to the exemplary embodiments of the present disclosure has been described above in conjunction with FIG. 4. Next, a computing device according to the exemplary embodiment of the present disclosure will be described in conjunction with to FIG. 5.

FIG. 5 shows a schematic diagram of the computing device, 5, according to an exemplary embodiment of the present disclosure.

Referring to FIG. 5, the computing device 5 may include a memory 51 and a processor 52, and the memory 51 stores a computer program. When the computer program is executed by the processor 52, a method of transmitting signals based on the RF front-end module according to the exemplary embodiments of the present disclosure is implemented.

In the exemplary embodiments of the present disclosure, when the computer program is executed by the processor 52, the following steps may be implemented: selecting a first signal transmitting interface from among the first transmitting interface and the second transmitting interface of the RF transceiver and selecting a second signal transmitting interface from among the third transmitting interface and the fourth transmitting interface of the RF transceiver, based on the frequency of the network cell in which the RF transceiver is currently located, controlling the pathway selector switch to establish a first transmitting pathway by connecting the first signal transmitting interface to the first amplifier module, transmitting a first signal through the first transmitting pathway and transmitting a second signal through a second transmitting pathway corresponding to the second signal transmitting interface, wherein the RF front-end module comprising an RF transceiver, a pathway selector switch, and a first amplifier module, wherein the RF transceiver comprises a first transmitting interface, a second transmitting interface, a third transmitting interface, and a fourth transmitting interface, the first transmitting interface and the second transmitting interface being selectively connected to the first amplifier module via the pathway selector switch.

The computing device 5 may receive input data F_IN (e.g., data derived from network cell signals received by the RF transceiver 201) and determine the frequency of the network cell in which the RF transceiver is currently located based on the input data F_IN. Based on the determined frequency, the computing device 5 may determine which transmitting interfaces (e.g., transmitting interfaces matching with a frequency band or bands of the network cell) should be utilized as part of transmitting pathways, among the interfaces TX1_a, TX2_a, TX1_b and TX2_b. The computing device 5 may output control signals CNTL_OUT based on the determination. For example, a control signal(s) CNTL_OUT may be output to the switch(es) 102/202/320 and/or the RFIC 300 to establish the appropriate switching states of the switches to select the desired transmitting interfaces, and the appropriate upconversion frequencies of the RFIC 300, based on the network cell frequency determination.

The computing devices in embodiments of the present disclosure may include, but are not limited to, devices such as mobile phones, notebook computers, PDAs (personal digital assistants), PADs (tablet computers), desktop computers, and the like. The computing device shown in FIG. 5 is only an example, and should not impose any limitation on the function and scope of use of the embodiments of the present disclosure.

The method of transmitting signals based on the RF front-end module according to the exemplary embodiments of the present disclosure have been described above with reference to FIGS. 1-5. However, it should be understood: the RF front-end module shown in FIGS. 1-3 may be respectively configured with software, hardware, firmware or any combination of the above to perform specific functions, and the computing device shown in FIG. 5 is not limited to including the above shown components, but some components may be added or deleted according to needs, and the above components may also be combined.

The RF front-end module according to the exemplary embodiments of the present disclosure, including: an RF transceiver, comprising a first transmitting interface, a second transmitting interface, a third transmitting interface, and a fourth transmitting interface; a pathway selection switch, connected to the first transmitting interface and the second transmitting interface, and for selecting, from among the first transmitting interface and the second transmitting interface, an interface matching with a frequency of the network cell in which it is currently located; a first amplifier module, wherein the first transmitting interface and the second transmitting interface are selectively connected to the first amplifier module via the pathway selection switch, wherein one of the first transmitting interface and the third transmitting interface is used as an interface for a first transmitting pathway, and one of the second transmitting interface and the fourth transmitting interface is used as an interface for a second transmitting pathway, thus enabling multiplexing of a Long Term Evolution (LTE) transmitting pathway in Long Term Evolution (LTE) and 5G dual connectivity (ENDC) scenarios through internal switching of the first transmitting interface and the second transmitting interface (e.g., TX1_a/TX2_a) and combining the signal transmission with a signal transmission through the third or fourth transmitting interface (e.g., TX1_b/TX2_b).

Although the present disclosure has been specifically shown and described with reference to the exemplary embodiments thereof, those skilled in the art should understand that various changes of the forms and details can be made without departing from the spirit and scope of the present disclosure as defined by the claims.

What is claimed is:

1. A radio frequency (RF) front-end module, comprising:
an RF transceiver, comprising a first transmitting interface, a second transmitting interface, a third transmitting interface, and a fourth transmitting interface;
a pathway selection switch, connected to the first transmitting interface and the second transmitting interface, for selecting, from among the first and second transmitting interfaces, an interface matching with a frequency of a network cell in which the RF transceiver is currently located; and
a first amplifier module, wherein the first transmitting interface and the second transmitting interface are selectively connected to the first amplifier module via the pathway selection switch,
wherein one of the first transmitting interface and the third transmitting interface is used as an interface for a first transmitting pathway, and one of the second transmitting interface and the fourth transmitting interface is used as an interface for a second transmitting pathway.

2. The RF front-end module according to claim 1, further comprising:
a second amplifier module connected to the third transmitting interface; and
a third amplifier module connected to the fourth transmitting interface.

3. The RF front-end module according to claim 2, wherein the first amplifier module is a low frequency amplifier module, the second amplifier module is a medium-high frequency amplifier module, and the third amplifier module is a high frequency amplifier module.

4. The RF front-end module according to claim 1, wherein the first transmitting interface is a long term evolution transmitting interface, the second transmitting interface is a 5G low frequency transmitting interface, the third transmitting interface is a medium-high frequency transmitting interface, and the fourth transmitting interface is an ultra-high frequency transmitting interface.

5. The RF front-end module according to claim 1, wherein the first transmitting pathway and the second transmitting pathway are in an operating state simultaneously.

6. The RF front-end module according to claim 1, wherein the first amplifier module is selectively used for long-term evolution signal transmission and 5G low-frequency signal transmission.

7. A method of transmitting signals based on a radio frequency (RF) front-end module, the RF front-end module comprising an RF transceiver, a pathway selector switch, and a first amplifier module, wherein the RF transceiver comprises a first transmitting interface, a second transmitting interface, a third transmitting interface, and a fourth transmitting interface, the first transmitting interface and the second transmitting interface being selectively connected to the first amplifier module via the pathway selector switch, the method comprising:
selecting a first signal transmitting interface from among the first transmitting interface and the second transmitting interface of the RF transceiver and selecting a second signal transmitting interface from among the third transmitting interface and the fourth transmitting interface of the RF transceiver, based on a frequency of a network cell in which the RF transceiver is currently located;
controlling the pathway selector switch to establish a first transmitting pathway by connecting the first signal transmitting interface to the first amplifier module; and
transmitting a first signal through the first transmitting pathway and transmitting a second signal through a second transmitting pathway corresponding to the second signal transmitting interface.

8. The method according to claim 7, wherein the RF front-end module further comprises:
a second amplifier module connected to the third transmitting interface; and
a third amplifier module connected to the fourth transmitting interface.

9. The method according to claim 8, wherein the first amplifier module is a low frequency amplifier module, the second amplifier module is a medium-high frequency amplifier module, and the third amplifier module is a high frequency amplifier module.

10. The method according to claim 7, wherein the first transmitting interface is a long term evolution transmitting interface, the second transmitting interface is a 5G low frequency transmitting interface, the third transmitting interface is a medium high frequency transmitting interface, and the fourth transmitting interface is an ultra-high frequency transmitting interface.

11. The method according to claim 7, wherein the first transmitting pathway and the second transmitting pathway are in an operating state simultaneously.

12. The method according to claim 7, wherein the first amplifier module is selectively used for long-term evolution signal transmission and 5G low-frequency signal transmission.

13. A computer-readable storage medium storing a computer program, wherein when the computer program is executed by a processor, the processor implements a method of transmitting signals based on an RF front-end module, the RF front-end module comprising an RF transceiver, a pathway selector switch, and a first amplifier module, wherein the RF transceiver comprises first, second, third and fourth transmitting interfaces, the first transmitting interface and the second transmitting interface being selectively connected to the first amplifier module via the pathway selector switch, the method comprising:
selecting a first signal transmitting interface from among the first transmitting interface and the second transmitting interface of the RF transceiver and selecting a second signal transmitting interface from among the third transmitting interface and the fourth transmitting interface of the RF transceiver, based on the frequency of the network cell in which the RF transceiver is currently located;
controlling the pathway selector switch to establish a first transmitting pathway by connecting the first signal transmitting interface to the first amplifier module; and
transmitting a first signal through the first transmitting pathway and transmitting a second signal through a second transmitting pathway corresponding to the second signal transmitting interface.

14. The computer-readable storage medium according to claim 13, wherein the RF front-end module further comprises:
a second amplifier module connected to the third transmitting interface; and
a third amplifier module connected to the fourth transmitting interface.

15. The computer-readable storage medium according to claim 14, wherein the first amplifier module is a low frequency amplifier module, the second amplifier module is a medium-high frequency amplifier module, and the third amplifier module is a high frequency amplifier module.

16. The computer-readable storage medium according to claim 13, wherein the first transmitting interface is a long term evolution transmitting interface, the second transmitting interface is a 5G low frequency transmitting interface, the third transmitting interface is a medium high frequency transmitting interface, and the fourth transmitting interface is an ultra-high frequency transmitting interface.

17. The computer-readable storage medium according to claim 13, wherein the first transmitting pathway and the second transmitting pathway are in an operating state simultaneously.

18. The computer-readable storage medium according to claim 13, wherein the first amplifier module is selectively used for long-term evolution signal transmission and 5G low-frequency signal transmission.
